(19) United States
(12) Patent Application Publication
(10) Pub. No.: US 2026/0348767 A1
(43) Pub. Date: Nov. 5, 2026

(54) DISTRIBUTED TEMPERATURE SENSOR SYSTEM WITH PROTECTED THERMOCOUPLE WIRE

(71) Applicant: PRECISE DOWNHOLE SERVICES LTD., Nisku (CA)

(72) Inventor: Michael Melnychuk, Nisku (CA)

(21) Appl. No.: 19/664,619

(22) Filed: Apr. 30, 2026

Related U.S. Application Data
(60) Provisional application No. 63/798,414, filed on May 1, 2025.

(51) Int. Cl. G01K 1/14; G01K 1/08; G01K 7/04; G01K 11/324

(52) U.S. Cl. CPC G01K 1/146; G01K 1/08; G01K 7/04; G01K 11/324; G01K 2213/00

(57) ABSTRACT

A thermocouple cable and a distributed temperature sensing (DTS) system which includes at least one thermocouple wire or bundle with at least one helically wound protective wire installed along its length.

### CROSS-REFERENCE TO RELATED APPLICATIONS

This application claims priority to, and the benefit of, United States Provisional Patent Application No. 63/798,414, filed on May 1, 2025, the entire contents of which are incorporated herein by reference.

### FIELD OF THE INVENTION

The present invention relates to thermocouples and thermocouple cables in a distributed temperature sensing system.

### BACKGROUND

Distributed temperature sensing (DTS) systems are used to determine temperature profiles in environments such as a well bore. A laser transmits a light pulse into an optical fiber extending into the well bore. The light pulse reflects (backscatters) along the optical fiber to a fiber optic receiver and processing unit at the surface. The local temperature conditions at different depths of the well bore affect the local optical characteristics of the optical fiber, which results in reflections with different local shifts due to the Raman scattering effect. The reflections relative to the pulsed light are shifted in accordance with the temperature of the atoms along the fiber. The backscattered light is processed as a function of time to derive temperature as a function of well depth, with earlier backscatter indicating the temperature at relatively shallow depths, and later backscatter indicating the temperature at relatively deep depths. Such time-to-depth conversion is possible because the speed at which light travels through the fiber is known. The processing unit analyzes the reflected light to detect these amplitude shifts to compute a temperature profile along the length of the optical fiber.

The optical fiber is conventionally installed in a small diameter, stainless steel coiled tubing (SS CT), typically 1/8” to about ¾” diameter, which are referred to as control lines. A common configuration uses two ¼” SS CT control lines, which are installed within a larger 1.25” or a 1.5” outer tubing. Typically, the outer tubing is carbon steel coil tubing (CS CT), as shown in prior art FIG. 1.

It is desirable to include a thermocouple cable inside the outer CS CT in order to calibrate the optical fiber DTS system, however, the CS CT may have a rough inner surface as well as a longitudinal weld. These imperfections can physically damage the insulation coating on thermocouple wires as they are pulled into the CS CT.

### SUMMARY OF THE INVENTION

In one aspect, disclosed is a distributed temperature sensing (DTS) system comprising an outer coil tubing and a control line disposed within the outer coil tubing, and a thermocouple cable disposed within the outer coil tubing comprising at least one thermocouple wire or bundle having at least one helically wound protective wire installed along its length.

In another aspect, disclosed is a thermocouple cable comprising at least one thermocouple wire or bundle having at least one helically wound protective wire installed along its length. In some embodiments, the thermocouple cable comprises a shared conductor wire and at least two thermocouple wires, wherein at least one thermocouple wire has a helically wound protective wire installed along its length. Preferably, each thermocouple wire and/or the shared conductor wire is protected with a helically wound protective wire.

In some embodiments, the thermocouple wire or bundle can be insulated with a polymer, for example, a polyimide. The protective wire can itself be insulated.

In another aspect, disclosed is a method of installing a thermocouple cable comprising at least one thermocouple wire or bundle into a coil tubing, comprising the step of protecting the at least one thermocouple wire or bundle with a helically wound protective wire, and pulling the thermocouple cable into the coil tubing.

In some embodiments, the thermocouple cable is pulled into the coil tubing along side a control line having a fiber optic cable.

### BRIEF DESCRIPTION OF THE DRAWINGS

The following drawings form part of the specification and are included to further demonstrate certain embodiments or various aspects of the invention. In some instances, embodiments of the invention can be best understood by referring to the accompanying drawings in combination with the detailed description presented herein. The description and accompanying drawings may highlight a certain specific example, or a certain aspect of the invention. However, one skilled in the art will understand that portions of the example or aspect may be used in combination with other examples or aspects of the invention.

FIG. 1 shows a prior art coil tubing configuration with an CS CT outer tubing and two SS CT control lines.

FIG. 2 shows a schematic representation of a downhole sensor system having a protected thermocouple cable assembled in accordance with one example of the present invention.

FIG. 3 shows a protective wire helically wound around a thermocouple wire.

### DETAILED DESCRIPTION

As used herein, the term “helix” means a three-dimensional spiral curve, such as the shape of a cylindrical coil spring or the thread of a screw. “Helical” means substantially having the shape of a helix. A helix has a pitch, which is the vertical distance between adjacent turns of the helix, as well as a diameter, which is the horizontal dimension of the helix.

As used herein, the “hot end” is the end of a thermocouple cable which is intended to be installed downhole, whereas the “cold end” is the end which remains at the surface and is connected to a data collection system which reads the thermocouple readings. The surface data collection system is not part of this invention. The hot and cold ends are identified to designate the orientation of the cable, and not to limit any temperature limitations at either end, or relative to one another.

As used herein, "high temperature materials" are those which do not experience significant degradation in their relevant properties at temperatures above about 150°C, or above about 200°C, more preferably 250°C, and most preferably 300°C. For example, high temperature materials may soften at elevated temperatures, but still maintain sufficient solidity to function as intended.

As used herein, “polyimide insulated wire” or “polyimide insulated conductor” is a metal wire coated with a layer of an insulating material comprising a polyimide (or a polyimide tape). The coating layer may comprise other polymers, such as PTFE or PFA, however it will comprise at least 50% (wt.) polyimide.

“Polyimide” is a class of polymers containing repeating imide groups, which are functional groups consisting of two acyl groups bound to nitrogen. The imide groups can be formed by condensation reactions of an aromatic anhydride group with an aromatic amine.

In one aspect of the invention, the invention comprises a distributed sensor system, such as a distributed temperature sensing (DTS) system comprising an outer coiled tubing 10 and at least one inner control line tubing 12 disposed within the outer tubing. A thermocouple cable 14 is inserted into the outer coiled tubing 10, and comprises at least one thermocouple wire or a thermocouple bundle of wires, and comprises at least one protective wire helically wound around the wire or bundle of wires.

The thermocouple wire may comprise a polyimide enameled wire, such as an enameled copper wire, which can be between about 50 m to about 2000 m (or longer) in length. A polyimide enameled wire is a wire which is dip-coated in a polyimide, providing a thin, uniform coating on the wire. The wire may comprise a standard 24 gauge (AWG) wire. A suitable polyimide enameled wire is described in co-pending US Provisional Patent Application No. 63/681,679, filed on Aug. 9, 2024, which is incorporated herein by reference.

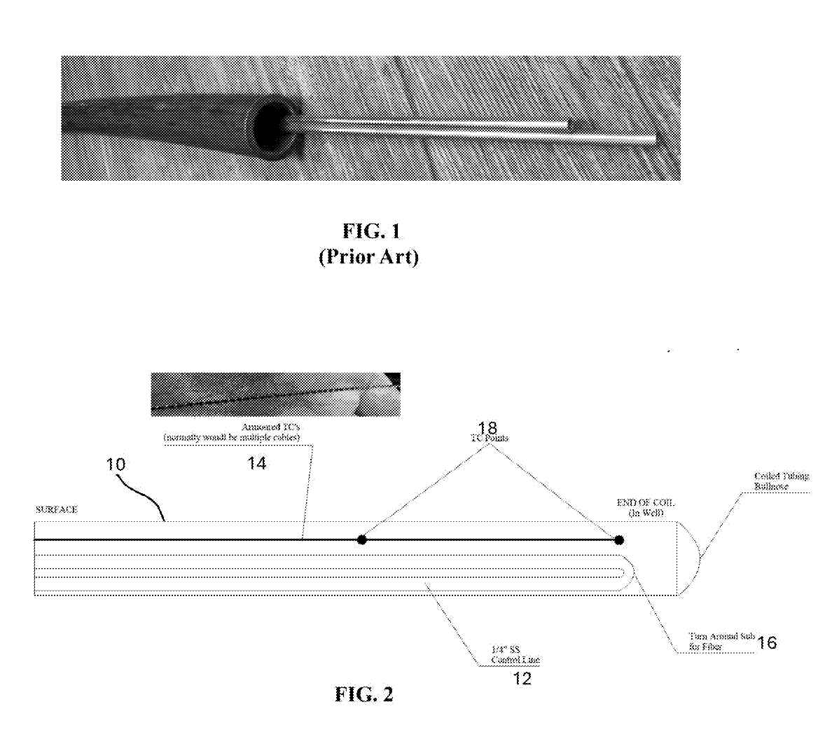

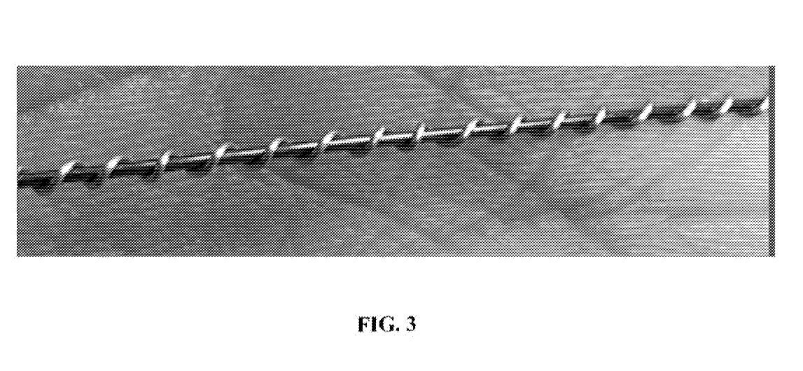

In one embodiment, the sensor system is formed by first installing a fiber optic cable into a desired length of control line tubing, which may have two tubing strings joined by a U-shaped turn around sub 16 at their lower end, as shown in FIG. 2. The double control line may then be pulled into the outer coil tubing 10, along with the thermocouple cable 14 having a protected thermocouple wire or bundle.

The thermocouple cable 14 may include a support cable and a shared thermocouple conductor wire, or a shared conductor wire which also functions as a support cable, and at least one thermocouple wire which is electrically connected to the shared conductor to form a thermocouple point 18. Suitable thermocouple cables are described in US Patent Application No. 16/750,803, which is incorporated herein by reference.

Although certain embodiments described herein comprise a shared conductor wire, the thermocouple cable is not limited to a shared conductor configuration. In some embodiments, the thermocouple cable may comprise dedicated wire pairs, wherein two individual wires are used for each thermocouple temperature measurement point, without a shared conductor.

FIG. 2 shows two thermocouple points 18, however, the thermocouple cable may comprise a plurality of thermocouple wires and thermocouple points. In preferred embodiments, each thermocouple conductive wire is each electrically insulated for the length of the cable with a polyimide coating.

In preferred embodiments, at least one and preferably each thermocouple wire in the thermocouple cable is protected by a helically wound protective wire.

The protective wire, which may itself be coated with an insulating coat, is wound around a thermocouple wire or bundle with a sufficiently tight helical pitch that the thermocouple cable itself does not contact the inner surface of the outer tubing as it is being pulled into and through the tubing. In some embodiments, the protective wire covers between about 15% to about 80% of the wire surface area, preferably between about 20% to about 50%. There should be sufficient coverage so that the wire is suitably protected. Excessive coverage provides no additional protection and may be more expensive to produce.

The helical wire wrap may comprise a single helix, or a plurality of helices short of a complete braided wire protective layer, which is not cost effective. If more than one helical wrap is used, the helices may be crossing (i.e., opposing helical orientations) or non-overlapping (i.e., aligned helical orientations) such as in a double helix. The helical wire wrap may comprise an insulated coating, although it is not necessary as the protective wire wrap does not itself conduct any electricity. However, in some embodiments, the protective wire wrap may be a conductor. The helical protective wire may itself comprise a protective coating. The helical wrap may also comprise any suitable metal alloy, or any other protective material used to bundle or protect thermocouple wires.

In addition to or as an alternative to the helically wound protective wire, the entire thermocouple bundle or an individual thermocouple wire may be enclosed within an armored conduit, or may have an armored or protective wrap applied therearound. Such armored conduit or protective wrap may comprise any suitable metal alloy, PTFE, polyimide tape, or any other protective material suitable for protecting the enameled thermocouple wires contained therein. The armored conduit or wrap provides additional protection against physical damage to the thermocouple bundle or individual wire during installation and operation within the coil tubing.

### Interpretation

The description of the present invention has been presented for purposes of illustration and description, but it is not intended to be exhaustive or limited to the invention in the form disclosed. Many modifications and variations will be apparent to those of ordinary skill in the art without departing from the scope and spirit of the invention. Embodiments were chosen and described in order to best explain the principles of the invention and the practical application, and to enable others of ordinary skill in the art to understand the invention for various embodiments with various modifications as are suited to the particular use contemplated. To the extent that the following description is of a specific embodiment or a particular use of the invention, it is intended to be illustrative only, and not limiting of the claimed invention.

The corresponding structures, materials, acts, and equivalents of all means or steps plus function elements in the claims appended to this specification are intended to include any structure, material, or act for performing the function in combination with other claimed elements as specifically claimed.

References in the specification to "one embodiment", "an embodiment", etc., indicate that the embodiment described may include a particular aspect, feature, structure, or characteristic, but not every embodiment necessarily includes that aspect, feature, structure, or characteristic. Moreover, such phrases may, but do not necessarily, refer to the same embodiment referred to in other portions of the specification. Further, when a particular aspect, feature, structure, or characteristic is described in connection with an embodiment, it is within the knowledge of one skilled in the art to combine, affect or connect such aspect, feature, structure, or characteristic with other embodiments, whether or not such connection or combination is explicitly described. In other words, any element or feature may be combined with any other element or feature in different embodiments, unless there is an obvious or inherent incompatibility between the two, or it is specifically excluded.

It is further noted that the claims may be drafted to exclude any optional element. As such, this statement is intended to serve as antecedent basis for the use of exclusive terminology, such as "solely," "only," and the like, in connection with the recitation of claim elements or use of a "negative" limitation. The terms “preferably,” “preferred,” “prefer,” “optionally,” “may,” and similar terms are used to indicate that an item, condition or step being referred to is an optional (not required) feature of the invention.

The singular forms "a," "an," and "the" include the plural reference unless the context clearly dictates otherwise. The term "and/or" means any one of the items, any combination of the items, or all of the items with which this term is associated.

As will be understood by one skilled in the art, for any and all purposes, particularly in terms of providing a written description, all ranges recited herein also encompass any and all possible sub-ranges and combinations of sub-ranges thereof, as well as the individual values making up the range, particularly integer values. A recited range (e.g., weight percents or carbon groups) includes each specific value, integer, decimal, or identity within the range. Any listed range can be easily recognized as sufficiently describing and enabling the same range being broken down into at least equal halves, thirds, quarters, fifths, or tenths. As a non-limiting example, each range discussed herein can be readily broken down into a lower third, middle third and upper third, etc.

As will also be understood by one skilled in the art, all ranges described herein, and all language such as "up to", "at least", "greater than", "less than", "more than", "or more", and the like, include the number(s) recited and such terms refer to ranges that can be subsequently broken down into sub-ranges as discussed above.

1. A distributed temperature sensing (DTS) system comprising an outer coil tubing and a control line disposed within the outer coil tubing, and a thermocouple cable disposed within the outer coil tubing comprising at least one thermocouple wire or bundle having at least one helically wound protective wire installed along its length.

2. A thermocouple cable comprising at least one thermocouple wire or bundle, wherein the cable and/or the at least one thermocouple wire or bundle has at least one helically wound protective wire installed along its length.

3. The thermocouple cable of claim 1, which comprises a shared conductor wire and at least two thermocouple wires, wherein at least one thermocouple wire has a helically wound protective wire installed along its length.

4. The thermocouple cable of claim 3, wherein each thermocouple wire and/or the shared conductor wire is protected with a helically wound protective wire.

5. The thermocouple cable of claim 2, wherein the thermocouple cable comprises dedicated wire pairs, each dedicated wire pair comprising two individual thermocouple wires forming a thermocouple temperature measurement point.

6. The thermocouple cable of claim 2, wherein the thermocouple cable or an individual thermocouple wire or bundle is enclosed within an armored conduit or has an armored or protective wrap applied therearound.

7. The thermocouple cable of claim 6, wherein the armored conduit or protective wrap comprises a metal alloy, PTFE, polyimide tape, or a combination thereof.

8. The thermocouple cable of claim 2, wherein the at least one thermocouple wire or bundle and/or the protective wire is polymer insulated.

9. The thermocouple cable of claim 8, wherein each of the at least one thermocouple wire or bundle is insulated with a polyimide.

10. The thermocouple cable of claim 2, wherein the helically wound protective wire covers about 15% to about 80% of the wire surface area.

11. The thermocouple cable of claim 10, wherein the helically wound protective wire covers about 20% to about 50% of the wire surface area.

12. The thermocouple cable of claim 2, wherein the helical wound protective wire comprises a single helix or a plurality of helices short of a complete braided wire protective layer.

13. The thermocouple cable of claim 12, comprising two or more helices, either in opposing or non-overlapping orientations.

14. A sensor system comprising a thermocouple cable of claim 2, installed within a coil tubing.

15. A method of installing a thermocouple cable comprising at least one thermocouple wire or bundle into a coil tubing, comprising the step of protecting the at least one thermocouple wire or bundle with a helically wound protective wire, and pulling the thermocouple cable into the coil tubing.

16. The method of claim 15, wherein the thermocouple cable is pulled into the coil tubing along side a control line having a fiber optic cable.

17. A thermocouple cable comprising at least one thermocouple wire or bundle, wherein the cable and/or the at least one thermocouple wire or bundle is enclosed within an armored conduit or has an armored or protective wrap applied therearound.

18. The thermocouple cable of claim 17, wherein the armored conduit or protective wrap comprises a metal alloy, PTFE, polyimide tape, or a combination thereof.

19. The thermocouple cable of claim 17, wherein the at least one thermocouple wire or bundle and/or the protective wire is polymer insulated.
